(19) United States
(12) Patent Application Publication
(10) Pub. No.: US 2017/0111249 A1
(43) Pub. Date: Apr. 20, 2017

(54) DETECTION AND MANAGEMENT OF ERROR CONDITIONS FOR WIRELESSLY DELIVERED MULTIMEDIA CONTENT

(71) Applicant: ARRIS Enterprises, Inc., Suwanee, GA (US)

(72) Inventor: Charles Hardt, Lawrenceville, GA (US)

(21) Appl. No.: 14/883,806

(22) Filed: Oct. 15, 2015

(51) Int. Cl. H04L 12/26; H04W 28/04; H04W 24/08

(52) U.S. Cl. CPC H04L 43/0829; H04W 24/08; H04W 28/04

(57) ABSTRACT

Methods, systems, and computer readable media can be operable to facilitate the identification of multimedia content playback errors at a client device. Methods, systems, and computer readable media described herein are operable to monitor for packet loss and underflow conditions at a client device, alert instances of packet loss and/or underflow conditions, and initiate troubleshooting of problems in the delivery of content from an access point to the client device. Alerts and troubleshooting actions may be determined based upon packet loss instances and/or underflow conditions identified over a duration of content playback at a client device.

### TECHNICAL FIELD

This disclosure relates to the detection and management of error conditions for wirelessly delivered multimedia content.

### BACKGROUND

Multimedia content delivered over a wireless network can be particularly vulnerable to problems arising in the transmission of the content to a client device and in the processing of the content at the client device. For example, data packets associated with content may be lost or dropped during the delivery of the content from a wireless access point to a client device. When a client device does not receive each data packet associated with a piece of multimedia content, a user may experience quality degradation (e.g., video stalling, macro blocking, etc.) in the display of the content.

Typically, one or more buffers are used at a client device to account for the non-deterministic rate at which packets are delivered to a client device from an access point providing a wireless network. The one or more buffers can temporarily store packets as they are received from an access point, and the client device can read packets from the one or more buffers for decoding and output. The rate at which a buffer is filled may depend on the bandwidth available to a client device.

Bandwidth allocated to a client device may depend on various factors, such as congestion of an associated wireless network, and an underflow condition may arise if the one or more buffers at a client device receive packets at a lower bit rate than the bit rate at which packets are read from the one or more buffers. For example, if a decoder is reading packets from a buffer at a faster rate than the rate at which packets are written into the buffer, the situation may arise where the buffer is emptied and the decoder has no packet to read from the buffer. An underflow condition can result in a stalled or fragmented picture in the output of the associated multimedia content.

A relatively small number of dropped packets or underflow conditions occurring at a client device during a given period of time may not result in quality degradation that is visible to a user. However, if the number of packet loss instances or underflow conditions reaches a certain level during playback of associated multimedia content, a user may observe quality degradations in the display of the content. Currently, a user waits until quality degradation is observed in the display of multimedia content before determining that troubleshooting actions should be taken to solve the observed problems. Therefore, a need exists for improving methods and systems for identifying multimedia content playback errors at a client device.

### BRIEF DESCRIPTION OF THE DRAWINGS

FIG. 1 is a block diagram illustrating an example network environment operable to facilitate the identification of multimedia content playback errors at a client device.

FIG. 2 is a block diagram illustrating an example component operable to facilitate the identification of multimedia content playback errors at a client device.

FIG. 3 is a flowchart illustrating an example process operable to facilitate the identification of multimedia content playback errors at a client device.

FIG. 4 is a block diagram of a hardware configuration operable to facilitate the identification of multimedia content playback errors at a client device.

Like reference numbers and designations in the various drawings indicate like elements.

### DETAILED DESCRIPTION

It is desirable to improve upon methods and systems for identifying multimedia content playback errors at a client device. Methods, systems, and computer readable media described herein are operable to monitor for packet delivery errors (e.g., packet loss and/or underflow conditions) at a client device, alert instances of packet delivery errors, and initiate troubleshooting of problems in the delivery of content from an access point to the client device. In embodiments, a potential for multimedia error conditions can be recognized at a client device based on identified packet loss instances and/or underflow conditions at the client device during playback of multimedia content. The client device may alert the potential for error conditions and initiate steps for troubleshooting problem(s) contributing to the error conditions. Multimedia content may include audio and/or video content, and multimedia error conditions may include errors in the output of the associated audio and/or video content.

Methods, systems, and computer readable media can be operable to facilitate the identification of multimedia content playback errors at a client device. Methods, systems, and computer readable media described herein are operable to monitor for packet loss and underflow conditions at a client device, alert instances of packet loss and/or underflow conditions, and initiate troubleshooting of problems in the delivery of content from an access point to the client device. Alerts and troubleshooting actions may be determined based upon packet loss instances and/or underflow conditions identified over a duration of content playback at a client device. In embodiments, a determination to alert and/or troubleshoot problems may be based on an identification of an increasing number of packet loss instances and/or underflow conditions at a client device, such that the underlying problem(s) may be solved before the quality of output content is degraded to a level that is noticeable by a user.

An embodiment of the invention described herein may include a method comprising: (a) receiving, at a client device, multimedia content as one or more data packets, wherein the multimedia content is received over a wireless connection to an access point; (b) identifying one or more packet delivery errors at the client device; (c) determining that the one or more identified packet delivery errors indicates a content output error; and (d) outputting an alert recognizing the indication of a content output error.

According to an embodiment of the invention, a packet delivery error comprises a dropped packet instance.

According to an embodiment of the invention, the dropped packet instance is identified based upon a discontinuity in continuity counter values associated with successively received packets.

According to an embodiment of the invention, a packet delivery error comprises an underflow condition associated with a buffer receiving the one or more data packets.

According to an embodiment of the invention, the underflow condition is identified based upon a comparison of the relative positions of a write pointer and read pointer associated with the buffer.

According to an embodiment of the invention, the method described herein further comprises: (a) maintaining a count of the number of packet delivery errors identified at the client device over a predetermined duration of time; (b) incrementing the count of the number of packet delivery errors each time a packet delivery error is identified at the client device; and (c) wherein, the determination that the one or more identified packet delivery errors indicates a content output error is made when the count of the number of packet delivery errors reaches a predetermined threshold.

According to an embodiment of the invention, the alert recognizing the indication of a content output error is output to a user through a display interface associated with the client device.

According to an embodiment of the invention, the alert recognizing the indication of a content output error is output to the access point as a wireless message.

According to an embodiment of the invention, the alert recognizing the indication of a content output error initiates troubleshooting of an underlying problem causing the identified packet delivery errors.

According to an embodiment of the invention, the troubleshooting comprises changing the channel used to transport communications between the access point and the client device from a first channel to a second channel, the second channel being less congested than the first channel.

An embodiment of the invention described herein may include an apparatus comprising: (a) a first interface configured to be used to receive multimedia content as one or more data packets, wherein the multimedia content is received over a wireless connection to an access point; (b) a module configured to: (i) identify one or more packet delivery errors; and (ii) determine that the one or more identified packet delivery errors indicates a content output error; and (c) a second interface configured to be used to output an alert recognizing the indication of a content output error.

According to an embodiment of the invention, a packet delivery error comprises a dropped packet instance, and the module is further configured to identify the dropped packet instance based upon a discontinuity in continuity counter values associated with successively received packets.

According to an embodiment of the invention, a packet delivery error comprises an underflow condition associated with a buffer receiving the one or more data packets, and the module is further configured to identify the underflow condition based upon a comparison of the relative positions of a write pointer and read pointer associated with the buffer.

According to an embodiment of the invention, the module described herein is further configured to: (a) maintain a count of the number of packet delivery errors identified over a predetermined duration of time; (b) increment the count of the number of packet delivery errors each time a packet delivery error is identified; and (c) wherein, the determination that the one or more identified packet delivery errors indicates a content output error is made when the count of the number of packet delivery errors reaches a predetermined threshold.

According to an embodiment of the invention, the alert recognizing the indication of a content output error is output to the access point as a wireless message.

An embodiment of the invention described herein may include one or more non-transitory computer readable media having instructions operable to cause one or more processors to perform the operations comprising: (a) receiving, at a client device, multimedia content as one or more data packets, wherein the multimedia content is received over a wireless connection to an access point; (b) identifying one or more packet delivery errors at the client device; (c) determining that the one or more identified packet delivery errors indicates a content output error; and (d) outputting an alert recognizing the indication of a content output error.

According to an embodiment of the invention, the alert recognizing the indication of a content output error is output to the access point as a wireless message, and the alert recognizing the indication of a content output error initiates troubleshooting of an underlying problem causing the identified packet delivery errors, the troubleshooting comprising changing the channel used to transport communications between the access point and the client device from a first channel to a second channel, the second channel being less congested than the first channel.

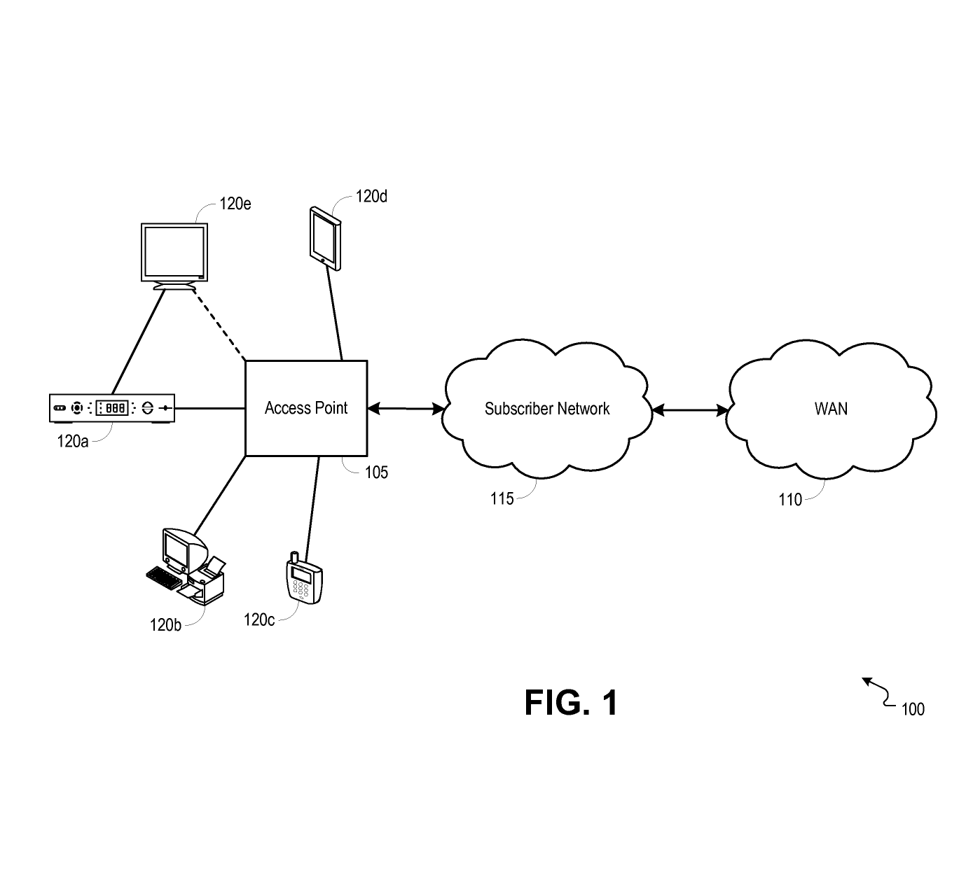

FIG. 1 is a block diagram illustrating an example network environment 100 operable to facilitate the identification of multimedia content playback errors at a client device. In embodiments, an access point 105 may provide video, audio and/or data services to a subscriber by communicating with a wide area network (WAN) 110 through a connection to a subscriber network 115 (e.g., hybrid fiber-coaxial network, fiber network, cellular network, high speed data network, etc.). The access point 105 may include a gateway device, a broadband modem, a wireless router including an embedded modem, or any other device operable to route communications between one or more client devices and a network. The access point 105 may provide a local network for delivering services to one or more client devices (e.g., a local area network (LAN), a wireless local area network (WLAN), a personal area network (PAN), etc.). A subscriber can request, receive and interact with multimedia and/or data services through a client device 120a-e. A client device 120a-e may include a set-top box (STB) 120a, computer 120b, mobile device 120c, tablet 120d, television 120e, and any other device operable to receive multimedia and/or data services. Multimedia and/or data services may be received at a client device 120a-e through a connection to an access point 105. It should be understood that a television 120e may receive multimedia and/or data services through a connection to an access point 105 and/or a STB 120a. While the components shown in FIG. 1 are shown separate from each other, it should be understood that the various components can be integrated into each other.

The access point 105 may provide a WLAN for client devices 120a-e within range of the access point 105, and multimedia and/or data services may be provided to client devices 120a-e through wireless communications (e.g., Wi-Fi). The bit rate at which communications are passed over a WLAN may vary according to many different factors, the number of client devices 120a-e connected to the WLAN being one such factor. As a result of a varying bitrate, client devices 120a-e may buffer multimedia content as it is received. For example, a client device 120a-e may store packets of a received multimedia stream in a buffer for a period of time before outputting the packets to a decoder such that the decoder receives the packets at a more consistent bit rate.

When a WLAN provided by an access point 105 becomes congested to a certain point, client devices 120a-e generally receive multimedia content at lower bit rate. When the bit rate at which a client device 120a-e receives content falls to a certain level, the rate at which packets are loaded into the client device's buffer may fall below the rate at which packets are output from the buffer for playback of the associated multimedia content. A shortfall in bit rate of incoming packets into the buffer can lead to an underflow event, wherein a read pointer catches up to a write pointer at the buffer, and the read pointer is therefore pointing to an empty slot in the buffer. When an underflow event occurs at a buffer, the device's decoder becomes starved of packets needed to output the associated multimedia content at an expected quality level. For example, an underflow event can lead to a stalled or fragmented picture.

In embodiments, a client device 120a-e can monitor the relative positions of the write and read pointers of an associated buffer, and the client device can maintain a count of the number of underflow events that occur at the buffer. When the read pointer and write pointer are pointing at the same slot in a buffer, the determination can be made that an underflow event has occurred, and each time an underflow event is identified, the count of underflow events can be incremented. The number of underflow events over a certain period of time can provide an indication of errors in the output of multimedia associated with the received packet stream. In embodiments, a client device 120a-e may be configured to output an alert when a predetermined number of underflow events occur over a predetermined period of time. For example, the client device 120a-e can alert a user (e.g., through a display interface associated with the client device 120a-e) or an access point 105 that errors may exist in the display of multimedia associated with the stream received by the client device 120a-e.

In embodiments, multimedia content may be received by a client device 120a-e as a stream of packets (e.g., Moving Picture Experts Group packets). Each received packet may include a continuity value identifying the sequential order of the packet relative to other packets of a multimedia stream (e.g., the value may be included within a packet identifier (PID) associated with the packet). If the client device 120a-e receives a packet having a continuity value that is not expected (e.g., the continuity value is something other than the continuity value of the last received packet incremented by one), the client device 120a-e can determine that one or more packets have been dropped or otherwise lost. In embodiments, a discontinuity in the continuity values of received packets may be expected, in which case the discontinuity will not result in a determination that packets have been lost or dropped. For example, a discontinuity flag within the PID of a received packet may provide an indication that a discontinuity in the sequential order of packets is expected.

A client device 120a-e can maintain a count of the number of instances where a determination is made that one or more packets have been dropped or otherwise lost. For example, each time a discontinuity in the continuity values of successively received packets is identified, the count of packet loss instances can be incremented. The number of packet loss instances over a certain period of time can provide an indication of errors in the output of multimedia associated with the received packet stream. In embodiments, a client device 120a-e may be configured to output an alert when a predetermined number of packet loss instances occur over a predetermined period of time. For example, the client device 120a-e can alert a user (e.g., through a display interface associated with the client device 120a-e) or an access point 105 that errors may exist in the display of multimedia associated with the stream received by the client device 120a-e.

In embodiments, an access point 105 can request and/or periodically receive reports from client devices 120a-e, the reports including data on the number of underflow events and/or packet loss instances identified over a predetermined period of time at the client device 120a-e. Client devices 120a-e may also output a report to the access point 105 when a predetermined number of underflow events or packet loss instances are identified over a predetermined period of time. When the access point 105 receives an indication of quality issues (e.g., excessive underflow events or packet loss instances) at a client device 120a-e, the access point 105 may take action to alleviate the quality issues. For example, based upon a report received from a client device 120a-e, the access point 105 can determine whether to switch to a new channel for supporting the associated WLAN. A report identifying an excessive number of underflow events or packet loss instances may indicate that the current wireless channel (e.g., the channel used to transport communications between the access point 105 and client devices 120a-e) used by the access point 105 is congested. The access point 105 can scan for other wireless channels, determine the level of congestion on each channel, identify a least-congested channel, and switch to the least-congested channel.

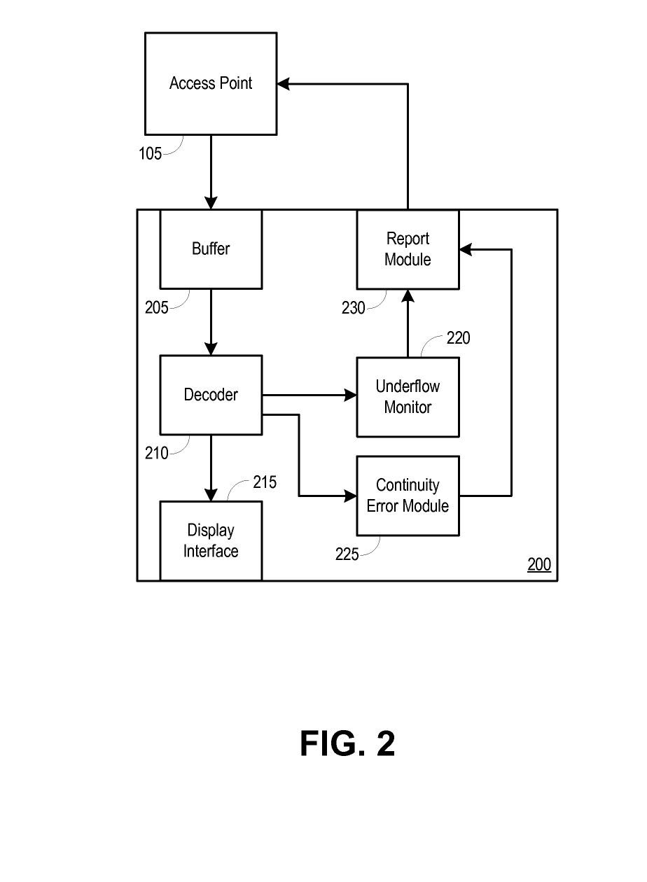

FIG. 2 is a block diagram illustrating an example component 200 operable to facilitate the identification of multimedia content playback errors at a client device. The component 200 may include a buffer 205, a decoder 210, a display interface 215, an underflow monitor 220, a continuity error module 225, and a report module 230. In embodiments, the component 200 is within a client device 120a-e of FIG. 1.

In embodiments, multimedia and/or data services may be received at the component 200 through a connection to an access point 105. For example, the component 200 may receive multimedia and/or data services as wireless communications (e.g., Wi-Fi) transported over a WLAN provided by the access point 105. The bit rate at which wireless communications are received at the component 200 may vary according to many different factors. The component 200 may buffer multimedia content as it is received at a buffer 205. For example, the component 200 may store packets of a received multimedia stream in the buffer 205 for a period of time before outputting the packets to a decoder 210 such that the decoder 210 receives the packets at a more consistent bit rate. With the decoder 210 receiving multimedia stream packets at a more consistent bit rate, the decoder 210 can decode and output the packets to a user through a display interface 215.

In embodiments, the buffer 205 may include a plurality of slots within which packets associated with a multimedia stream may be temporarily stored. The buffer 205 may also include a write pointer and a read pointer. The write pointer may point to a buffer slot into which a received packet is to be loaded, and the read pointer may point to a buffer slot from which a stored packet is to be output. It will be appreciated by those skilled in the relevant art that various types of buffers and buffer configurations may be used to buffer multimedia streams received at the component 200.

When a WLAN provided by the access point 105 becomes congested to a certain point, the bit rate at which the component 200 receives multimedia content may be reduced. When the bit rate at which the component 200 receives content is reduced, the rate at which multimedia stream packets are loaded into the buffer 205 may fall below the rate at which packets are output from the buffer 205 for playback of the associated multimedia content. A shortfall in bit rate of incoming packets into the buffer 205 can lead to an underflow event, wherein the read pointer catches up to the write pointer at the buffer 205, and the read pointer is therefore pointing to an empty slot in the buffer 205. When an underflow event occurs at the buffer 205, the decoder 210 becomes starved of packets needed to output the associated multimedia content at an expected quality level.

In embodiments, an underflow monitor 220 can monitor the relative positions of the write and read pointers of the buffer 205, and can maintain a count of the number of underflow events that occur at the buffer 205. For example, the underflow monitor 220 can retrieve the read pointer position from the decoder 210. When the read pointer and write pointer are pointing at the same slot in the buffer 205, the underflow monitor 220 can make the determination that an underflow event has occurred, and each time an underflow event is identified, the count of underflow events can be incremented. The number of underflow events occurring over a certain period of time can provide an indication of errors in the output of multimedia associated with the received packet stream.

In embodiments, the underflow monitor 220 can identify an underflow event when the number of packets within the buffer 205 drops below a threshold portion of the capacity of the buffer 205. For example, when the buffer 205 is emptied below the threshold portion (e.g., twenty (20) percent, thirty (30) percent, etc.), the underflow monitor 220 can determine that an underflow event has occurred or is eminent. It should be understood that the threshold portion of the buffer 205 may be configured based upon various factors (e.g., data rate at which frames of the content are received, resolution of content, etc.).

In embodiments, the underflow monitor 220 can output statistics associated with identified underflow events to a report module 230. When, a predetermined number of underflow events occur over a predetermined period of time, such that errors in the output of the associated multimedia stream may be indicated, the underflow monitor 220 can alert the report module 230. It should be understood that the predetermined number of underflow events that are indicative of content output errors may be configured at a client device based upon various factors (e.g., data rate at which frames of the content are received, resolution of content, etc.). In response to the alert, the report module 230 may generate and output a message to the access point 105 informing the access point 105 of the error indication. For example, information associated with underflow events identified at the component 200 can be encapsulated into a message (e.g., within a private element associated with the access point 105), and the message can be output to the access point 105. The message can be output to the access point 105 periodically, in response to a request for information associated with underflow events, or when the information associated with underflow events indicates errors in the output of multimedia content at the component 200.

In embodiments, multimedia content may be received by the component 200 as a stream of packets (e.g., Moving Picture Experts Group packets). Each received packet may include a continuity value identifying the sequential order of the packet relative to other packets of a multimedia stream (e.g., the value may be included within a packet identifier (PID) associated with the packet as a continuity counter). In embodiments, the decoder 210 can determine that a packet in a packet stream has been lost or dropped based on the identification of a discontinuity in continuity values associated with received packets.

To provide an example determination of dropped or lost packets based on continuity counters, where valid continuity counter values are the integers between zero (0) and fifteen (15), if a packet having a continuity counter value of four (4) is received at the decoder 210, the decoder 210 can expect that the next packet received will have a continuity counter value of five (5). If the next packet received at the decoder 210 has a continuity counter value of anything other than five (5), the decoder 210 can make the determination that a packet has been lost or dropped. Using the above example, if a packet having a continuity counter value of fifteen (15) is received at the decoder 210, the decoder 210 can expect that the next packet received will have a continuity counter value of zero (0). In embodiments, a discontinuity in the continuity counter values of received packets may be expected, in which case the discontinuity will not give rise to a determination that packets have been lost or dropped. For example, a discontinuity flag within the PID of a received packet may provide an indication that a discontinuity in the sequential order of packets is expected.

In embodiments, a continuity error module can maintain a count of the number of instances where a determination is made that one or more packets have been dropped or otherwise lost. For example, each time a discontinuity in the continuity values of successively received packets is identified at the decoder 210, the count of packet loss instances can be incremented at the continuity error module 225. The number of packet loss instances over a certain period of time can provide an indication of errors in the output of multimedia associated with the received packet stream.

In embodiments, the continuity error module 225 can output statistics associated with identified packet loss instances to a report module 230. When a predetermined number of packet loss instances occur over a predetermined period of time, such that errors in the output of the associated multimedia stream (e.g., content output errors such as macro-blocking, stalling, fragmentation, etc.) may be indicated, the continuity error module 225 can alert the report module 230. For example, identifying one-thousand (1,000) errors over a period of one (1) minute may provide an indication that a user is experiencing content output errors. It should be understood that the predetermined number of packet loss instances that are indicative of content output errors may be configured at a client device based upon various factors (e.g., data rate at which frames of the content are received, resolution of content, etc.).

In response to the alert, the report module 230 may generate and output a message to the access point 105 informing the access point 105 of the error indication. For example, information associated with packet loss instances identified at the component 200 can be encapsulated into a message (e.g., within a private element associated with the access point 105), and the message can be output to the access point 105. The message can be output to the access point 105 periodically, in response to a request for information associated with packet loss instances, or when the information associated with packet loss instances indicates errors in the output of multimedia content at the component 200.

In embodiments, the report module 230 may generate and output a message to a display interface used to display multimedia content to a user (e.g., display interface 215). For example, the message can inform a user of a problem(s) existing in the delivery of content to an associated client device, and may further provide the user with troubleshooting instructions for solving the underlying problem(s). In embodiments, the report module 230 may generate and output a message targeted to an upstream network device (e.g., multiple systems operator (MSO) controlled devices such as headend devices, network maintenance servers, etc.). For example, the message can inform an MSO that a user is experiencing a problem(s) in the delivery of content to a client device, and the MSO can take action to determine whether the problem(s) is localized at the user's premise or is more widespread across a network.

In embodiments, an access point 105 can receive reports from the component 200, the reports including data on the number of underflow events and/or packet loss instances identified over a predetermined period of time at the component 200. When the access point 105 receives an indication of quality issues (e.g., excessive underflow events or packet loss instances) at the component 200, the access point 105 may take action to alleviate the quality issues. For example, based upon a report received from the component 200, the access point 105 can determine whether to switch to a new channel for supporting the associated WLAN. A report identifying an excessive number of underflow events or packet loss instances may indicate that the wireless channel (e.g., the channel used to transport communications between the access point 105 and client devices 120a-e) currently used by the access point 105 is congested. The access point 105 can scan for other wireless channels, determine the level of congestion on each channel, identify a least-congested channel, and switch to the least-congested channel.

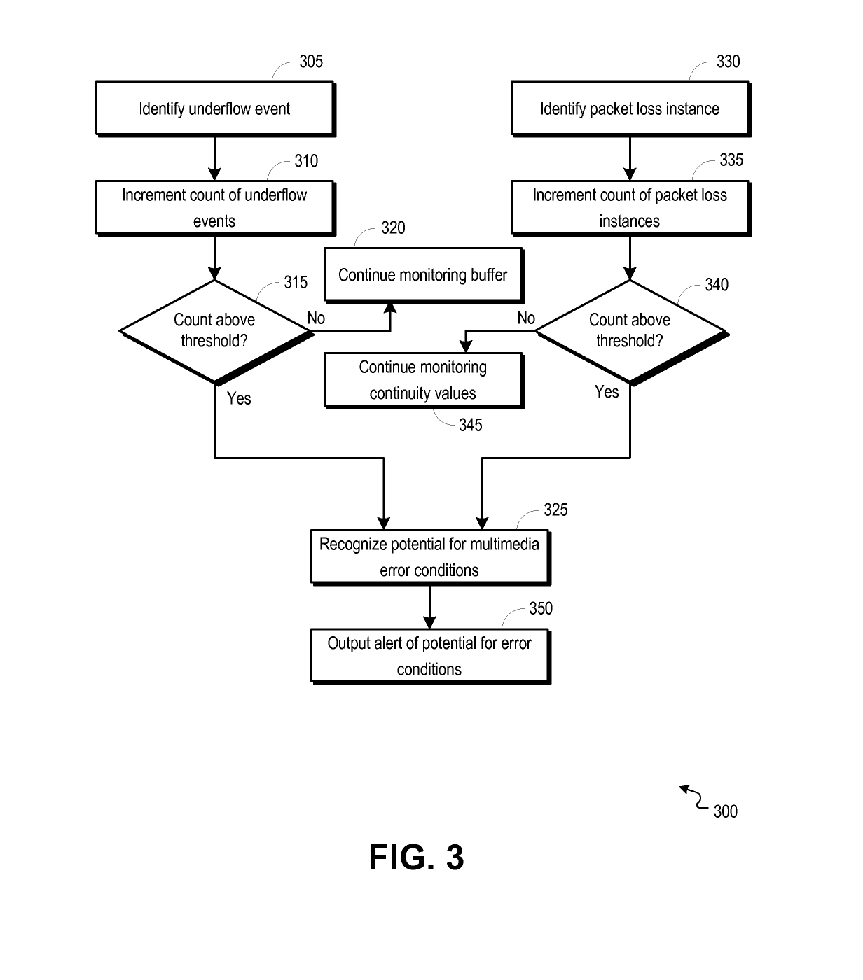

FIG. 3 is a flowchart illustrating an example process 300 operable to facilitate the identification of multimedia content playback errors at a client device. The process 300 can be carried out at a client device (e.g., client device 120a-e of FIG. 1) while the client device is receiving multimedia content over a wireless connection to an access point (e.g., access point 105 of FIG. 1). It should be understood that the process 300 may be carried out continuously or periodically. For example, in embodiments, multimedia content received at a client device may be monitored and summary reports may be given for predetermined durations.

At 305, an underflow event occurring at a client device may be identified. A shortfall in the bit rate of incoming packets into a buffer associated with the client device (e.g., buffer 205 of FIG. 2) can lead to an underflow event, wherein the read pointer catches up to the write pointer at the buffer 205, and the read pointer is therefore pointing to an empty slot in the buffer 205. An underflow event can starve an associated decoder (e.g., decoder 210 of FIG. 2) of packets, thereby creating the potential for errors and/or reduced quality in the output of the associated multimedia content. In embodiments, an underflow monitor 220 of FIG. 2 can monitor the relative positions of the write and read pointers of the buffer 205, and can maintain a count of the number underflow events that occur at the buffer 205. For example, the underflow monitor 220 can retrieve the read pointer position from the decoder 210. When the read pointer and write pointer are pointing at the same slot in the buffer 205, the underflow monitor 220 can make the determination that an underflow event has occurred.

It should be understood that an underflow event may be identified or indicated when the positions of the read and write pointers come within a threshold distance of each other. For example, a determination can be made that an underflow event is eminent when the read pointer comes within a certain number of slots (e.g., two (2), three (3), four (4), etc.) of the write pointer. Those skilled in the art will appreciate that the number of slots between the read and write pointers that is indicative of an eminent underflow condition may vary according to the size of the associated buffer, the data rate at which frames of the associated content are received into the buffer, the resolution of the associated content, and others.

When an underflow event is identified, a count of underflow events may be incremented at 310. In embodiments, the number of underflow events occurring over a period of time can provide an indication of errors in the output of multimedia associated with the received packet stream. It should be understood that the count of underflow events occurring at a client device may be periodically reset so that a count of underflow events occurring during a predetermined duration may be maintained (e.g., counting a number of underflow events occurring over a fifteen (15), thirty (30), sixty (60) second duration, or any other duration).

At 315, a determination can be made whether the count of underflow events is greater than a predetermined threshold. It should be understood that the predetermined threshold may be a number of underflow events that are indicative of content output errors, and the predetermined threshold may be configured at a client device based upon various factors (e.g., data rate at which frames of the content are received, resolution of content, etc.). It should be further understood that the predetermined threshold may be based upon a predetermined duration for which a count of underflow events is maintained. If the count of underflow events is not greater than the threshold, the client device can continue to monitor the buffer 205 for underflow events. If the count of underflow events is greater than the threshold, the process 300 can proceed to 325 where a potential for multimedia error conditions is recognized.

At 330, a packet loss instance occurring at a client device may be identified. In embodiments, each packet received at a client device may include a continuity value identifying the sequential order of the packet relative to other packets of a multimedia stream (e.g., the value may be included as a continuity counter within a packet identifier (PID) associated with the packet). A determination can be made that a packet in a packet stream has been lost or dropped based on the identification of a discontinuity in continuity values associated with received packets. For example, if the client device (e.g., at a decoder 210 of FIG. 2) receives a packet having a continuity value that is not expected (e.g., the continuity value is something other than the continuity value of the last packet received incremented by one), the client device can determine that one or more packets have been dropped or otherwise lost. In embodiments, a discontinuity in the continuity values of received packets may be expected, in which case the discontinuity will not result in a determination that packets have been lost or dropped. For example, a discontinuity flag within the PID of a received packet may provide an indication that a discontinuity in the sequential order of packets is expected.

When a packet loss instance is identified, a count of packet loss instances may be incremented at 335. For example, each time a discontinuity in the continuity values of successively received packets is identified (e.g., at a decoder 210 of FIG. 2), the count of packet loss instances can be incremented (e.g., at a continuity error module 225 of FIG. 2). In embodiments, the number of packet loss instances identified over a period of time can provide an indication of errors in the output of multimedia associated with the received packet stream. It should be understood that the count of packet loss instances occurring at a client device may be periodically reset so that a count of packet loss instances occurring during a predetermined duration may be maintained (e.g., counting a number of packet loss instances occurring over a fifteen (15), thirty (30), sixty (60) second duration, or any other duration).

At 340, a determination can be made whether the count of packet loss instances is greater than a predetermined threshold. It should be understood that the predetermined threshold may be a number of packet loss instances that is indicative of content output errors, and the predetermined threshold may be configured at a client device based upon various factors (e.g., data rate at which frames of the content are received, resolution of content, etc.). It should be further understood that the predetermined threshold may be based upon a predetermined duration for which a count of packet loss instances is maintained. For example, identifying one-thousand (1,000) errors over a period of one (1) minute may provide an indication that a user is experiencing content output errors. If the count of packet loss instances is not greater than the threshold, the client device can continue to monitor for packet discontinuities. If the count of packet loss instances is greater than the threshold, the process 300 can proceed to 325 where a potential for multimedia error conditions is recognized.

At 325, a potential for multimedia error conditions may be recognized. In embodiments, a potential for error conditions may be recognized based upon an identification of underflow events and/or packet loss instances exceeding a predetermined threshold at a client device. For example, when underflow events and/or packet loss instances occur at a client device, a user may experience degradation in the quality of multimedia content output by the client device. In embodiments, the number of underflow events or packet loss instances that may give rise to an indication that multimedia error conditions may be experienced at a client device can be based upon the data rate of frames associated with the multimedia content. For example, frames of higher resolution content will be received by a client device at a higher data rate than frames of lower resolution content, and a larger number of underflow events or packet loss instances may be expected and tolerated for content having frames that are received at a higher data rate.

At 350, an alert of the potential for error conditions can be output. In embodiments, statistics associated with identified underflow events and/or packet loss instances can be gathered and output from the client device. For example, an alert may be output to a user (e.g., through a display interface), to a MSO or to an access point (e.g., through a report module 230 of FIG. 2). In embodiments, the report module 230 may generate and output a message to the access point 105 informing the access point 105 of the error indication. For example, information associated with underflow events and/or packet loss instances identified at the client device can be encapsulated into a message (e.g., within a private element associated with the access point 105 of FIG. 1), and the message can be output to the access point 105. The message can be output to the access point 105 periodically, in response to a request for information associated with underflow events or packet loss instances, or when the information associated with underflow events and/or packet loss instances indicates errors in the output of multimedia content at the client device.

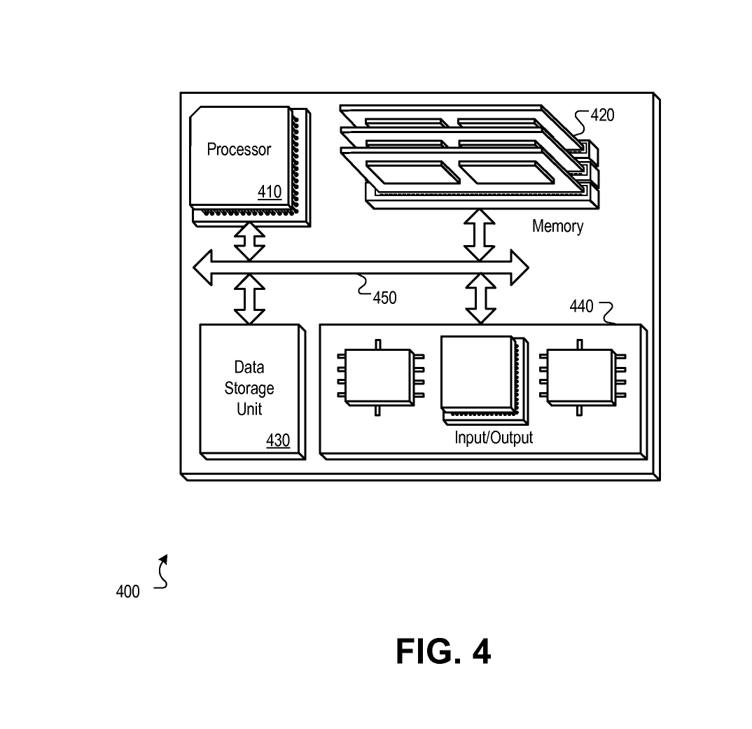

FIG. 4 is a block diagram of a hardware configuration 400 operable to facilitate the identification of multimedia content playback errors at a client device. The hardware configuration 400 can include a processor 410, a memory 420, a storage device 430, and an input/output device 440. Each of the components 410, 420, 430, and 440 can, for example, be interconnected using a system bus 450. The processor 410 can be capable of processing instructions for execution within the hardware configuration 400. In one implementation, the processor 410 can be a single-threaded processor. In another implementation, the processor 410 can be a multi-threaded processor. The processor 410 can be capable of processing instructions stored in the memory 420 or on the storage device 430.

The memory 420 can store information within the hardware configuration 400. In one implementation, the memory 420 can be a computer-readable medium. In one implementation, the memory 420 can be a volatile memory unit. In another implementation, the memory 420 can be a non-volatile memory unit.

In some implementations, the storage device 430 can be capable of providing mass storage for the hardware configuration 400. In one implementation, the storage device 430 can be a computer-readable medium. In various different implementations, the storage device 430 can, for example, include a hard disk device, an optical disk device, flash memory or some other large capacity storage device. In other implementations, the storage device 430 can be a device external to the hardware configuration 400.

The input/output device 440 provides input/output operations for the hardware configuration 400. In embodiments, the input/output device 440 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a client device 120a-e of FIG. 1 (e.g, STB, television, computer, tablet, mobile device, etc.). In embodiments, the input/output device can include driver devices configured to send communications to, and receive communications from one or more networks (e.g., WLAN provided by an access point 105 of FIG. 1, subscriber network 115 of FIG. 1, WAN 110 of FIG. 1, etc.).

Those skilled in the art will appreciate that the invention improves upon methods and systems for identifying multimedia content playback errors at a client device. The methods, systems, and computer readable media described in this disclosure are operable to monitor for packet loss and underflow conditions at a client device, alert instances of packet loss and/or underflow conditions, and initiate troubleshooting of problems in the delivery of content from an access point to the client device. Alerts and troubleshooting actions may be determined based upon packet loss instances and/or underflow conditions identified over a duration of content playback at a client device. Troubleshooting actions may be initiated upon the identification of packet loss instances and/or underflow conditions without having to rely on the user first discovering quality degradation in the output of associated multimedia content.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving, at a client device, multimedia content as one or more data packets, wherein the multimedia content is received over a wireless connection to an access point;
identifying one or more packet delivery errors at the client device;
determining that the one or more identified packet delivery errors indicates a content output error; and
outputting an alert recognizing the indication of a content output error.

2. The method of claim 1, wherein a packet delivery error comprises a dropped packet instance.

3. The method of claim 2, wherein the dropped packet instance is identified based upon a discontinuity in continuity counter values associated with successively received packets.

4. The method of claim 1, wherein a packet delivery error comprises an underflow condition associated with a buffer receiving the one or more data packets.

5. The method of claim 4, wherein the underflow condition is identified based upon a comparison of the relative positions of a write pointer and read pointer associated with the buffer.

6. The method of claim 1, further comprising:
maintaining a count of the number of packet delivery errors identified at the client device over a predetermined duration of time;
incrementing the count of the number of packet delivery errors each time a packet delivery error is identified at the client device; and
wherein, the determination that the one or more identified packet delivery errors indicates a content output error is made when the count of the number of packet delivery errors reaches a predetermined threshold.

7. The method of claim 1, wherein the alert recognizing the indication of a content output error is output to a user through a display interface associated with the client device.

8. The method of claim 1, wherein the alert recognizing the indication of a content output error is output to the access point as a wireless message.

9. The method of claim 1, wherein the alert recognizing the indication of a content output error initiates troubleshooting of an underlying problem causing the identified packet delivery errors.

10. The method of claim 9, wherein the troubleshooting comprises changing the channel used to transport communications between the access point and the client device from a first channel to a second channel, the second channel being less congested than the first channel.

11. An apparatus comprising:
a first interface configured to be used to receive multimedia content as one or more data packets, wherein the multimedia content is received over a wireless connection to an access point;
a module configured to:
identify one or more packet delivery errors; and
determine that the one or more identified packet delivery errors indicates a content output error; and
a second interface configured to be used to output an alert recognizing the indication of a content output error.

12. The apparatus of claim 11, wherein a packet delivery error comprises a dropped packet instance, and the module is further configured to identify the dropped packet instance based upon a discontinuity in continuity counter values associated with successively received packets.

13. The apparatus of claim 11, wherein a packet delivery error comprises an underflow condition associated with a buffer receiving the one or more data packets, and the module is further configured to identify the underflow condition based upon a comparison of the relative positions of a write pointer and read pointer associated with the buffer.

14. The apparatus of claim 11, wherein the module is further configured to:
maintain a count of the number of packet delivery errors identified over a predetermined duration of time;
increment the count of the number of packet delivery errors each time a packet delivery error is identified; and
wherein, the determination that the one or more identified packet delivery errors indicates a content output error is made when the count of the number of packet delivery errors reaches a predetermined threshold.

15. The apparatus of claim 11, wherein the alert recognizing the indication of a content output error is output to the access point as a wireless message.

16. One or more non-transitory computer readable media having instructions operable to cause one or more processors to perform the operations comprising:
receiving, at a client device, multimedia content as one or more data packets, wherein the multimedia content is received over a wireless connection to an access point;
identifying one or more packet delivery errors at the client device;
determining that the one or more identified packet delivery errors indicates a content output error; and
outputting an alert recognizing the indication of a content output error.

17. The one or more non-transitory computer-readable media of claim 16, wherein a packet delivery error comprises a dropped packet instance, and the dropped packet instance is identified based upon a discontinuity in continuity counter values associated with successively received packets.

18. The one or more non-transitory computer-readable media of claim 16, wherein a packet delivery error comprises an underflow condition associated with a buffer receiving the one or more data packets, and the underflow condition is identified based upon a comparison of the relative positions of a write pointer and read pointer associated with the buffer.

19. The one or more non-transitory computer-readable media of claim 16, wherein the instructions are further operable to cause one or more processors to perform the operations comprising:
maintaining a count of the number of packet delivery errors identified at the client device over a predetermined duration of time;
incrementing the count of the number of packet delivery errors each time a packet delivery error is identified at the client device; and
wherein, the determination that the one or more identified packet delivery errors indicates a content output error is made when the count of the number of packet delivery errors reaches a predetermined threshold.

20. The one or more non-transitory computer-readable media of claim 16, wherein the alert recognizing the indication of a content output error is output to the access point as a wireless message, and the alert recognizing the indication of a content output error initiates troubleshooting of an underlying problem causing the identified packet delivery errors, the troubleshooting comprising changing the channel used to transport communications between the access point and the client device from a first channel to a second channel, the second channel being less congested than the first channel.
